(19) United States
(12) Patent Application Publication
(10) Pub. No.: US 2003/0219573 A1
(43) Pub. Date: Nov. 27, 2003

(54) Absorbent product

(76) Inventor: Torgny Falk, Hisings-Backa (SE)

Correspondence Address: BURNS, DOANE, SWECKER & MATHIS, L.L.P., P.O. Box 1404, Alexandria, VA, 22313-1404, US

(21) Appl. No.: 10/397,268

(22) Filed: Mar. 27, 2003

Related U.S. Application Data
(60) Provisional application No. 60/367,486, filed on Mar. 27, 2002.

(51) Int. Cl. B32B 1/00

(52) U.S. Cl. 428/195.1

(57) ABSTRACT

An absorbent product, such as a panty liner, a sanitary towel, an incontinence protection or a tampon for absorption of urine, blood or menstrual fluid, comprising a fluid permeable surface layer facing the wearer during use, a fluid impermeable backing layer facing away from the wearer during use, and an absorbent body, positioned between the surface and backing layers, the absorbent body includes superabsorbent polymers (SAP). The SAP-material includes at least two variants, the first variant is a SAP with a cross-linking degree in the interval from 0.02 to 2.0%, and the second variant is a SAP with a cross-linking degree in the interval from 3.0 to 7.0%. An absorbent product is provided which is especially adapted for absorption of both blood and urine, the SAP low cross-linking degree being suitable for absorption of water, and the SAP of high cross-linking degree being suitable for absorption of blood-containing fluids.

### CROSS-REFERENCE TO RELATED APPLICATIONS

The present application claims the benefit of U.S. Provisional Application No. 60/367,486, filed in the United States on Mar. 27, 2002, the entire contents of which are hereby incorporated herein by reference.

### BACKGROUND OF THE INVENTION

The invention refers to an absorbent product, such as a panty liner, a sanitary towel or an incontinence protection, for absorption of blood-containing fluids and urine, which product comprises an absorbent body comprising SAP-material.

Materials of superabsorbent polymers (SAP) have become popular for use in various absorbent products. SAP-material has the ability to absorb liquid in an amount several times its own weight, which makes SAP suitable for use as a component in for example an absorbent body in a panty liner, a sanitary towel or a diaper.

Typically, SAP is added to the remaining absorbent body in the form of polymer particles. These particles are built up of superabsorbent polymer chains forming a network, which is held together by cross-linkings. In order to obtain these cross-linkings cross-linking agents are used.

For example, DE-A-19941423 discloses a SAP-polymer and its manufacture, which comprises (a) 55-99.9% (per weight) of an ethylene-containing polymerisable monomer, (b) 0-40% (per weight) of a with (a) copolymerisable monomer, (c) 0.01-5.0, preferably 0.1-2.0% (per weight), of a cross-linking agent, and (d) 0-30% (per weight) of a water-soluble polymer.

The degree of cross-linking determines the elasticity of the material, as well as its absorbent properties. A higher degree of cross-linking results in a more brittle material, but also a higher initial ability to absorb fluid, i.e. the SAP becomes quick, but obtains a lower total capacity to absorb a large volume, i.e. a lower total capacity. A low degree of cross-linking gives a viscous, expandable material, which has the capacity to absorb a large volume of liquid. However, a low degree of cross-linking may result in a relatively slow absorption. A reason for this is that the diffusion constant increases and the swelling is faster (at a higher cross-linking degree), but the total capacity decreases (“Modern superabsorbent polymer technology”, Buchholz and Graham, Wiley-VCH, 1998). A balance between these two extremes is therefore desirable.

A high degree of cross-linking also results in high gel strength. The gel strength is a measure of the ability of the SAP-gel to withstand pressure without losing fluid. A SAP-particle having a high gel strength thus has a high ability to keep fluid when it is subjected to load, such as when the wearer of an absorbent product sits down or lies in a way that the article, and the SAP-particle within it, is pressed together.

The fluids that must be absorbable by an absorbent product in the category of panty liners, sanitary towels or incontinence protections are primarily urine and blood-containing fluids, such as menstrual fluid. Urine is a water-based solution, which among others comprises various salts. Blood has a higher viscosity than urine. To about 45% blood comprises of blood cells and to about 55% of blood plasma. The blood plasma comprises inter alia salts, water and proteins (inter alia albumin, IgG and fibrinogen). The proteins constitute about 7 to 8% of the blood plasma. The amount of proteins in blood is of the magnitude 10¹⁷/ml blood, and the amount of blood cells is in the magnitude of 10⁹/ml blood.

At absorption of blood to a SAP-particle the proteins will interact to a much greater extent than the blood cells with the surface of the SAP-particles. The proteins give a negative effect on the absorption capacity of the SAP-particles. The SAP-particles are primarily intended for absorption of water. Thus it is important to design the surface of the SAP-particles in such a way that the transport of water molecules into the particles are facilitated. By making the surface of the SAP-particles hydrophilic, the ability of the proteins to interact with the surface of the particles will decrease. Tests (Nadarajah et al., “Modeling the Dynamics of Proteins Adsorption to Surfaces”, from ACS Symposium Series 602, Proteins at Interfaces II—Fundamentals and Applications (Horbett and Brash, 1995): chapter 13) have shown that a hydrophilic surface results in a lower degree of protein interaction. However, the water molecules are polar and will thus interact to a high degree with a hydrophilic surface. The same counts for salts, which in water solution are present as ions, and also will be attracted by the surface of the SAP-particles. In this way the transport of water and salt to the surface of the SAP-particles, and thus their possibility to be absorbed into the SAP-particles, will increase at expense of the protein accumulation at the surface, if the surface of the SAP-particles is hydrophilic. Moreover, a large difference in ionic concentration inside and outside a SAP-particle may give a high osmotic pressure, which contributes to a high absorption capacity.

Accordingly, the various fluids to be absorbed by an absorbent product in the technical area of the invention are different in their chemical character.

Today, a number of products concerning absorption of fluids having different chemical character exist. WO97/13484 discloses a so-called pore gradient for absorption of bodily fluids. This pore gradient extends in the Z-direction, in the direction of thickness, and comprises several layers of absorbent material having varying pore sizes in order to absorb fluids in an effective way.

EP-A-1077051 discloses a panty liner built up by two material layers, wherein the lower layer comprises SAP-material. WO96/23474 teaches an absorbent product for absorption of bodily fluids. This product has essentially two components: a collection component and a storage component. The purpose of the collection component, which is positioned between the source of fluid (the carrier) and the storage component, is to collect for example blood cells, and to allow for the liquid phase to be transported to and stored in the storage component. The storage component comprises SAP. However, none of these documents discloses SAP-material, which is especially adapted for blood absorption.

U.S. Pat. No. 5,985,432 describes a porous absorbent material, which, due to its favorable wettability and low contact angle for blood containing fluids (0-40°), is adapted for blood absorption. Furthermore, U.S. Pat. No. 5,241,009 describes an absorbent product, which may be used for absorption of blood. In this document a cross-linking degree of about 0.1-2.0% is recommended for blood absorption. U.S. Pat. No. 5,985,432 discloses a SAP having a cross-linking degree of 0.001 to 5% (per mole). In this case, the absorbent material comprises a polyether and/or a polycation bound to the absorbent polymer, which results in a contact angle for blood in the interval from 0 to 40°. These SAP-materials, having a relatively low degree of cross-linking, are however primarily suitable for absorption of water or urine. Since these products are not constituted for facilitating absorption of blood, with the specific composition of blood, they tend to not be functionable in cases where both urine and blood must be absorbed.

Accordingly, a number of technical solutions for absorption of blood and urine in the technical area exist. However, a problem not yet solved is to absorb blood and urine in the same absorbent body. Thus, there is a need for an absorbent body, which body is constituted in a way that both blood and urine may be absorbed in such an effective way that the risk for leakage is minimized.

The object of the present invention is to provide an absorbent product having an absorbent body, which body is constituted in such a way that both urine and blood-containing fluids is absorbed to a high extent.

### SUMMARY OF THE INVENTION

This and other objects are accomplished with the present invention, which discloses an absorbent product, such as a panty liner, a sanitary towel, an incontinence protection or a tampon for absorption of blood or menstrual fluid, which comprises a liquid-permeable surface layer, intended to face the user at use, a liquid-impermeable backing layer, intended to face away from the user at use, and an absorbent body, whereby the absorbent body comprises superabsorbent polymers (SAP), characterised by that the SAP-material is of at least two variants, wherein the first variant is a SAP having a cross-linking degree in the interval from 0.02 to 2.0%, and the second variant is a SAP having a cross-linking degree in the interval from 3.0 to 7.0%. Hereby, SAP-material adapted for absorption of urine is combined with SAP-material for absorption of blood-containing liquids.

In a preferred embodiment the absorbent body is constituted of an upper and a lower layer, whereby the upper layer comprises SAP-material which is adapted for blood absorption and the lower layer comprises SAP-material which is adapted for urine absorption. Hereby, a favorable absorption of both blood and urine is achieved, since the urine having a low viscosity easily is transported through the high cross-linking degree upper layer, to the lower layer having a high swell capacity.

### BRIEF DESCRIPTION OF THE DRAWINGS

FIG. 1 shows a panty liner according to one embodiment of the invention, in which the absorbent body comprises two layers.

FIG. 2 shows a cross-section of a fibre-structure, which after section is used as an absorbent body.

FIG. 3 shows a cross-section of a principal outline of an absorbent body according to one embodiment of the invention, in which the absorbent body comprises two material layers.

FIG. 4 shows an embodiment according to the invention having SAP-material in different zones.

FIG. 5 shows another embodiment according to the invention having SAP-material in different zones.

### DETAILED DESCRIPTION OF THE PREFERRED EMBODIMENTS

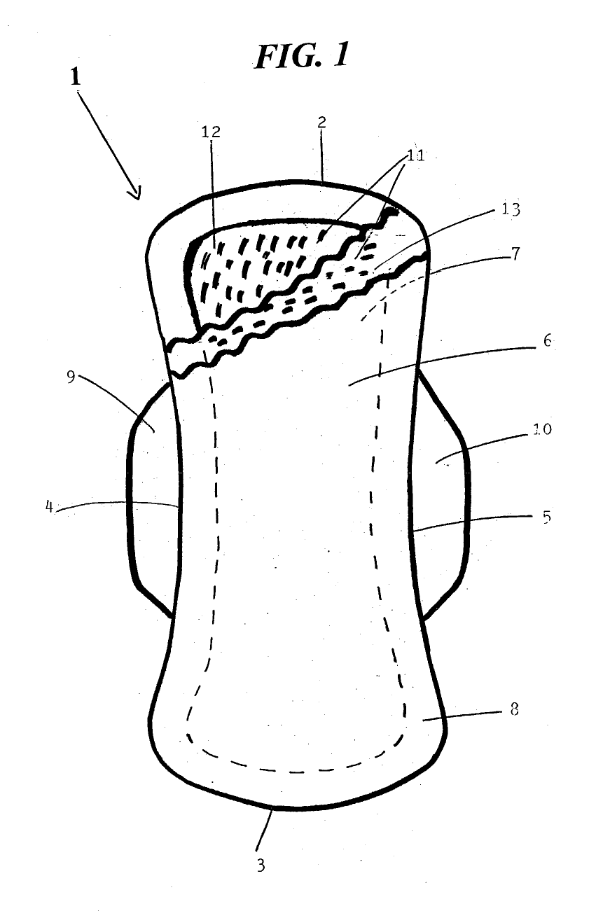

In FIG. 1 a principal sketch of a sanitary towel 1 according to the invention is shown. However, the invention is not limited to sanitary towels, but may also comprise other absorbent products, such as panty liners, incontinence protections and tampons, which are intended for absorption of blood, menstrual fluid and/or urine. In one embodiment the sanitary towel may include two short sides 2, 3 and two long sides 4, 5. A liquid permeable surface layer 6 is applied on the side of the sanitary towel 1 facing the wearer during use. The liquid permeable surface layer 6 suitable comprises a soft, skin-friendly material. Examples of suitable liquid permeable materials are different kinds of non-woven fibre materials. Other usable surface layers are perforated plastic films, nets, knitted, crocheted or woven textiles, and combinations and laminates of the listed material types.

The liquid-blocking backing layer 7 can be a liquid-impermeable material. Thin, liquid-proof plastic films are suitable for the purpose, but it is also possible to use materials which initially are liquid-permeable, but which are equipped with a coating of plastics, resin, or some other fluid-proof material. Hereby, the leakage of fluid form the underside of the absorbent product is prevented. The blocking layer 7 may therefore comprise any material meeting the criteria of liquid-impermeability, and exhibiting an appropriate sufficient flexibility and skin-friendliness. Examples of materials that are suitable for use as the blocking layer are plastic films, nonwovens and laminates of these. The plastic film may for example be of polyethylene, polypropylene, polyester or plastic fibres. The blocking layer may alternatively consist of a laminate of a liquid-permeable plastic layer, facing the absorbent body, and a non-woven facing the undergarment of the wearer. A construction of that kind provides a leakage-secure layer having a textile character. The fluid-blocking backing layer 7 may also consist of a vapour-permeable material. A breathable backing layer 7 of that kind may for example be a so-called SMS-material (spunbond-meltblown-spunbond) or a breathable plastic film consisting of polyethylene. A plastic film of that kind is disclosed in EP-A-283200. In order to uphold the breathability even when the material is applied on a product, the under-side should not be totally covered with fastening means.

The two wrapping layers (the surface layer and the backing layer 6, 7) may be connected to each other and optionally form a protruding connecting edge 8 around the contour line of the sanitary towel. The connection may be accomplished with any technique suitable for the purpose, such as gluing, welding or sewing. The two wrapping layers are not necessary, but may in some cases be suitable.

Between the surface layer and the backing layer 6, 7 a thin flexible absorbent core 11 is placed, which may comprise one or more material layers (12, 13). The absorbent core 11 is suitably manufactured by one or more layers of cellulose pulp. The pulp may originally be in the form of rolls, bales or sheets, which at the manufacture of the sanitary towel is dry-defibrated and transmitted in fluffed form to a pulp mat, sometimes including so-called superabsorbents, which are polymers having the ability to absorb water or bodily fluids in an amount of several times their own weight. An alternative to this is to dry-form a pulp mat, such as described in WO94/10956. Examples of other usable absorbent materials are different kinds of natural fibres, such as cotton fibres, peat or the like. Naturally, it is also possible to use absorbent synthetic fibres, or particles of a high-absorbing polymer material of the type, which at absorption chemically bind large amounts of liquid, during the formation of a liquid-containing gel, or mixtures of natural fibres or synthetic fibres. The absorbent body 11 may further comprise additional components, such as form-stabilising means, fluid-spreading means, or binders, such as for example thermoplastic fibres, which have been heat-treated to hold short fibres and particles to a connecting unit. It is also possible to use different types of absorbing foam materials in the absorbent body. Yet another variant is to produce the absorbent body of only SAP-material.

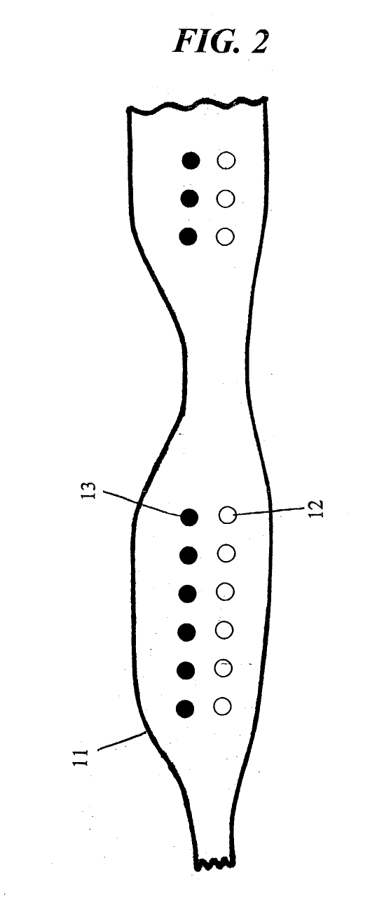

In FIG. 2 a cross-section of a fibre structure which is partially compressed is shown. The fibre structure may for example be of plastic, pulp, SAP or mixtures of these materials.

In a first embodiment of the invention the absorbent body comprises two different SAP-materials, whereby the first variant has a cross-linking degree in the interval from 0.02 to 2.0%, and the other variant has a cross-linking degree in the interval from 3.0 to 7.0%. Hereafter, the term “the first SAP-variant” refers to the SAP-variant having a low degree of cross-linking, and “the second SAP-variant” refers to the SAP-variant having a high degree of cross-linking. Thus, the first variant is a conventional SAP-material, having a high swell-capacity, and thereby suitable for absorption of urine. The second variant can be, for example, the SAP-material disclosed in SE0103961-9 (filed Nov. 27, 2001), the entire content of which is incorporated herein in its entirety. This second variant is especially suitable for the absorption of blood-containing fluids due to its high degree of cross-linking and its hydrophilic surface. In this way, an absorbent core is provided having the ability to absorb both blood and urine. Preferably, the first SAP-variant has a cross-linking degree in the interval from 0.1 to 1.0%, and the second variant has a cross-linking degree in the interval from 4.0 to 5.0%.

In another embodiment, the second SAP-variant, which is adapted for blood absorption, has a gel strength, which is higher than 18 kPa, preferably higher than 25 kPa, more preferably higher than 30 kPa. A SAP-material having a gel strength at this level have especially favorable blood absorption characteristics. For further details of the manufacture of SAP-particles of the second variant, as well as its absorption properties, see SE0103961-9. Typically, the first SAP-variant has a gel strength that is lower than 10 kPa, normally about 5 kPa.

The strength of the SAP-gel (shear modules) may for example be determined with a TA instruments AR 1000 N. For example, to 0.5 g SAP-sample 2.5 ml 0.9% NaCl-solution is added. The elasticity module of the SAP-samples is determined with a TA instruments AR 1000 N. The analyses are performed with a 40 mm acrylic parallel plate, cross hatched at 20° C. The procedure is oscillating and the samples are analysed between 0,1 and 100 Hz. The oscillating shear tension is 10.00 Pa. The measured shear tension is designated G′ and is measured at 1 Hz.

According to an embodiment of the invention, superabsorbent polymers (SAP) are manufactured of polyacrylic acid monomers, which are provided from KeboLab, for instance. The monomers are thereafter treated in order to form polymers. They are added to the other absorption material in the form beads, granules, foam, fibres, threads, film or the like. Granules are preferred in the invention, and they are used at an approximate size of 100 to 850 mm. Naturally, other manufacturing methods may be used if they generate SAPs having the above mentioned features.

Other materials that may be used to produce superabsorbent polymers suitable to use in the invention, include hydrolyzed starch-acrylonitrile graft copolymers, starch-acrylic acid graft copolymers, saponified vinyl acetate-acrylic ester copolymers, hydrolyzed acrylonitrile copolymers, hydrolyzed acrylamide copolymers, ethylene-maleic anhydride copolymers, isobutylene-maleic anhydride copolymers, poly(vinylsulfonic acid), poly(vinylphosphonic acid), poly(vinylphosphoric acid), poly(vinylsulfuric acid), sulfonated polystyrene, poly(aspartic acid), poly(lactic acid), and mixtures thereof, as well as mixtures of the above mentioned compounds and polyacrylic acid. Also other material combinations known in the technical area are of course possible to use, and are included in the scope of the invention.

The polymer chains are held together with cross-linkings, which are accomplished by the addition of a cross-linking agent, such as methyl-bisacrylamide (MBA), to the original polymers. Other possible cross-linking agents comprise for example aluminium sulphate, N,N′-methylenebisacrylamide, N,N′-methylenebismethacrylamide, ethylene glycol dimethacrylate, and trimethylolpropane triacrylate. It is to be understood by the skilled person that also other cross-linking agents giving a desired cross-linking are included in the scope of the invention.

According to an embodiment of the invention, the cross-linking agent is added to the SAP-polymer in a concentration of 0.02 to 2% (per mole), preferably 0.1 to 1% (per mole), for the first variant, and 3 to 7% (per mole), preferably 4 to 5% (per mole), for the second variant. For the second variant, these values have shown to result in especially advantageous absorption properties for blood or menstrual fluid. These values are measured at a load of 2 kPa, using the AUL-method (Absorption Under Load) in a AUL-cell, which has been modified by exchanging a standard filter to a metal filter (having a mesh size of 100×100 mm). These metal filters have enough large meshes for blood cells to pass (about 10 mm in diameter). The absorption capacity values mentioned here are measured according to edana 441.1-99 (centrifuge retention capacity).

The surface of the SAP-particles is treated in a way that it preferably exhibits a certain degree of wettability (hydrophilicity). The wettability is measured by the so-called contact angle. Defibrinogated sheep blood is standardly used to measure the contact angle for SAP-particles to be used for absorption of blood-containing fluids. The contact angle (see for example “Lexikon i KEMI”, Gleerups förlag, 1976, 1^{st} edition) specifies the angle between the surface and a water droplet, positioned on the surface. The more hydrophilic surface, the more compressed the droplet becomes (smaller angle). A surface showing a value for the contact angle below 90° is regarded as hydrophilic. In an absorbent product according to the invention a contact angle for the second variant of SAP material, which is smaller than 60° and preferably smaller than 40°, is exhibited, as measured with defibrinogated sheep blood.

The contact angle between defibrinogated sheep blood and the SAP-particles may be determined with a DAT 1100 Fibro System AB. The analyses are for example performed in normal laboratory environment at 22° C. and 50% relative air moisture. For the analyses a particle size of between 100 and 315 mm is for example chosen.

In order for the surface of the SAP-particles to exhibit the desired hydrophilicity, the surface can be treated with a surface modifier, such as aluminium chloride (AlCl₃) and/or aluminium sulphate (Al₂(SO₄)₃). At treatment of a SAP-particle surface with these ionic compounds, the chloride and/or sulphate ions will dissociate and a binding of the trivalent, positively charged aluminium ion is obtained on the surface. At absorption of water containing liquids, the water dipole will then be attracted to and bind to the aluminium ion. Other surface modifiers that may be used include silica compounds, such as silica oxides, organic compounds, such as ethylene carbonate, and tensides. All surface modifiers giving the desired effect, i.e. a desired contact angle, are fully possible for use in the invention.

A SAP-material according to the second variant may for example be treated and surface-modified as follows: To a 25% acrylic acid-solution, neutralised to 75%, methylenebisacrylamide is added to a cross-linking degree of 0.1 to 10%. The reaction is initiated with 0.1% mole of Va-044 (Wako Pure Chemical Industries LTD, Japan), and is neutralised with sodium ions (such as sodium hydroxide or sodium carbonate). The obtained gel is washed, dried, ground (Janke & Kunkel, Analysen Mühce A10) and fractionated to a size in the interval from 100 to 850 mm.

At surface-crosslinking the particles are evaporated in a solution of ethanol, aluminium chloride and sodium hydroxide. This is performed by mixing 25 ml 96% ethanol, 0.1 g water-free AlCl₃ and 300 ml 4M NaOH with 2 g SAP. The mix is allowed to cross-link for about 30 min at 70° C., during rotation. Thereafter, the ethanol is removed under vacuum.

In a preferred embodiment of the invention, the absorbent body essentially comprises an upper (13) and a lower layer (12), whereby each of the two SAP-variants are essentially present in one of the two layers. Hereby, one of the layers is especially adapted for absorption of blood and one is especially adapted for absorption of urine.

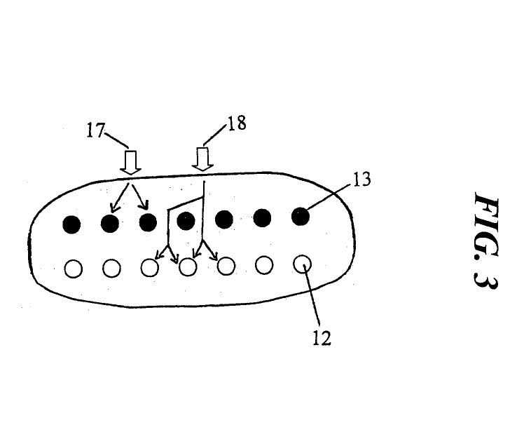

In an especially advantageous embodiment (FIG. 3) the SAP-material of the upper layer (13) is composed of the second SAP-variant, and the SAP-material of the lower layer (12) is composed of the first variant. Hereby, an absorbent body in the absorbent product is obtained, in which body the upper layer has a high degree of cross-linking and the lower layer has a low degree of cross-linking. Urine (18), which is a fluid of low viscosity will easily flow through the upper layer and primarily be absorbed by the lower layer. Blood-containing fluids (17), such as menstrual fluid, which fluids are relatively viscous, will be absorbed by the upper layer, and will thus essentially not flow down to the lower layer. Moreover, as the upper layer is strongly cross-linked the risk for gel blockage is reduced, since the strongly cross-linked polymers are not expanded in the same way as weakly cross-linked polymers, and will therefore not block the fluid transport.

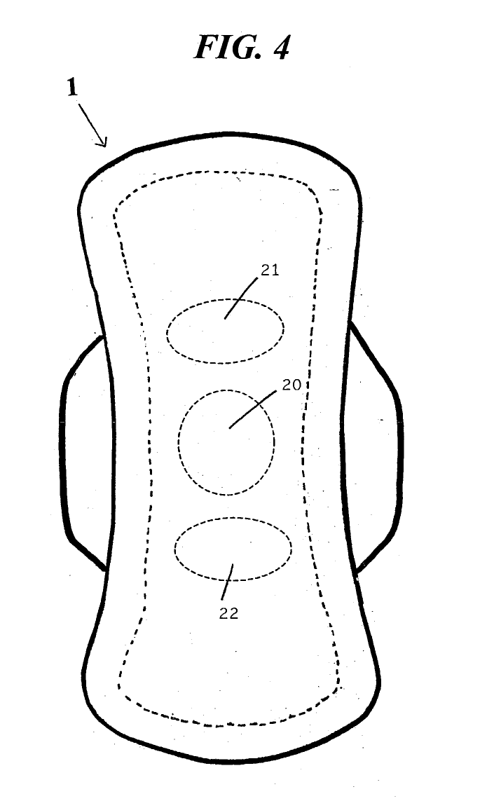

In another aspect of the invention, both SAP-variants may be arranged in such a way, that zones are formed in/at the absorbent body. For example, in one embodiment (FIG. 4) a zone of SAP-material of the second variant (high degree of cross-linking) is positioned in the centre of (longitudinally) the absorbent body (20), and one, two or more zones of SAP of the first variant (low degree of cross-linking) are positioned in front of (21) and/or behind (22) (longitudinally) the zone of the second variant (20). The purpose of this embodiment is to arrange the SAP-zones in such a way that they, at use, are close to the bodily parts of the wearer that gives off the bodily fluids that are to be absorbed, such as menstrual fluids and urine.

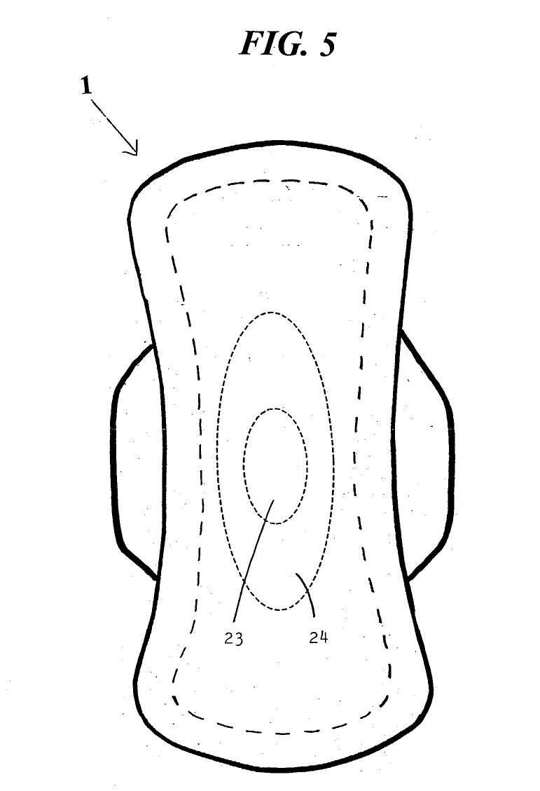

In another embodiment (FIG. 5), a zone of SAP of the second variant (23) is applied centrally on, at the middle of, the absorbent body, for example in the form of a circle, whereby SAP of the first variant is applied in a zone (24) around the SAP-zone of the second variant (23). The purpose is to arrange the SAP-variants in a way that for an absorption of the desired bodily fluids as effective as possible to be obtained.

In yet another embodiment both SAP-variants may be mixed in one layer, or in several layers, whereby for example the relative quantity ratio of the different variants of SAP-material is different in different layers, so that for example an upper layer comprises a majority of SAP of the second variant, and the lower layer comprises a majority of SAP of the first variant. Moreover, more than two layers may be used, whereby the various layers comprises different compositions of SAP-material.

Other variants and combinations of the above mentioned embodiments are also fully possible, as long as the absorbent body comprises SAP-material of at least two variants as described above.

A wearer suffering of for example mild incontinence will generally give off at least a few ml menstrual fluid and urine. According to a preferred embodiment the invention is thus designed in such a way that the upper layer has a total absorption capacity of at least 2 ml, and the lower layer has a total absorption capacity of at least 2 ml. In this way 2 ml blood-containing fluid may preferably be absorbed by the upper layer, and 2 ml urine of the lower layer. In another embodiment the invention is designed in order for the both layers total absorption capacities taken together to be approximately 15-20 ml. Thus, the absorbent product of the invention is for example especially suitable for mildly incontinent persons also having menstruation, or for other wearers for whom both urine and blood are given off.

In one embodiment of the invention, the SAP-material of the second variant has an absorption capacity of at least 6 g blood/g SAP, more preferably of at least 10 g blood/g SAP, and most preferably of at least 13 g blood/g SAP under load, and the first variant has an absorption capacity of at least 20 g salt solution/g SAP, more preferably at least 30 g salt solution/g SAP, and most preferably at least 35 g salt solution/g SAP under load (AUL). By salt solution is here for example meant 0.9% NaCl-solution, for example saline solution. The absorption capacity is measured according to edana 441.1-99 (centrifuge retention capacity).

The SAP-particles are added to the absorbent body in an amount of 1 to 100, preferably 10 to 60% of the total weight of the absorbent body, in order to achieve a good spreading and/or absorption capacity.

Between the surface layer 6 and the absorbent body 11 an inlet layer may be arranged. The purpose of the inlet layer is to direct liquid into the absorbent product, and to transport it down to the absorbent body 11. The inlet layer may be a low-density non-woven material.

At the downside of the absorbent product a fastening means may be applied. The fastening means comprises preferably glue, but it may also be a mechanical fastening means such as hook and loop, push buttons, friction linings, clamping means, or the like. The glue may be applied in one or more strings, or in any other pattern. Alternatively, the whole downside of the absorbent product 1 is lined with glue. It is also possible to use a fastening glue, which is breathable, and to apply it to the entire downside of the product, for it to function as a combined liquid-proof layer and fastening means. Moreover, the fastening means may be glue towards body, hydrogels or nothing at all.

On the fastening means, a protection layer may be applied, e.g. when glue is used as the fastening means. The protection layer is preferably a siliconised paper, but also other variants of protection layers are of course possible, such as waxed papers, embossed or release agent-treated plastic film, textile ribbons to fasten to hooks and loops, etc.

The absorbent product of the invention may further also comprise fastening tabs 9 and 10, which are applied along the long sides of the absorbent product. The purpose of the tabs is for them to be folded along the edge of the panty, and thereby keep the absorbent product in place. Furthermore, other kinds of fastening systems may be used.

Primarily, the absorbent product of the invention is a panty liner, a sanitary towel, or an incontinence protection, adapted for absorption of urine, blood or menstrual fluid.

In yet another aspect, the invention relates to the use of an absorbent product described above for the absorption of both urine and blood-containing fluids.

Although only preferred embodiments are specifically illustrated and described herein, it will be appreciated that many modifications and variations of the present invention are possible in light of the above teachings and within the purview of the appended claims without departing from the spirit and intended scope of the invention.

1. An absorbent product, for absorption of urine, blood, or menses, the absorbent product comprising:
a fluid permeable surface layer facing the wearer during use;
a fluid impermeable backing layer facing away from the wearer during use; and
an absorbent body, positioned between the surface layer and the backing layer, the absorbent body comprising superabsorbent polymer material, wherein the superabsorbent polymer material includes at least a first SAP variant and a second SAP variant, the first SAP variant being a SAP with a cross-linking degree in an interval from 0.02 to 2.0%, and the second SAP variant being a SAP with a cross-linking degree in an interval from 3.0 to 7.0%.

2. The absorbent product according to claim 1, wherein the first SAP variant has a cross-linking degree in the interval from 0.1 to 1.0%, and the second SAP variant has a cross-linking degree in the interval from 4.0 to 5.0%.

3. The absorbent product according to claim 1, wherein the second SAP variant has a gel strength higher than 18 kPa.

4. The absorbent product according to claim 3, wherein the second SAP variant has a gel strength higher than 25 kPa.

5. The absorbent product according to claim 4, wherein the second SAP variant has a gel strength higher than 30 kPa.

6. The absorbent product according to claim 1, wherein the second SAP variant shows a contact angle on its surface which is lower than 60°, as measured by defibrinogated sheep blood.

7. The absorbent product according to claim 1, wherein the absorbent body essentially comprises an upper and a lower layer, and each of the first and second SAP variants are present in at least one of the upper layer and the lower layer.

8. The absorbent product according to claim 7, wherein the SAP-material of the upper layer essentially is composed of the second SAP-variant, and the SAP-material in the lower layer essentially is composed of the first SAP-variant.

9. The absorbent product according to claim 7, wherein the upper layer has a total absorption capacity of at least 2 ml, and the lower layer has a total absorption capacity of at least 2 ml.

10. The absorbent product according to claim 7, wherein the upper layer is adapted for absorption of blood-containing fluids, and the lower layer is adapted for absorption of urine.

11. The absorbent product according to claim 1, wherein the superabsorbent polymer material is arranged in at least two zones in the absorbent body, whereby at least one zone essentially comprising SAP material of the first SAP variant, and at least one of the zones essentially comprising SAP-material of the second SAP variant.

12. The absorbent product according to claim 11, wherein a zone of SAP-material of the second variant is positioned in the middle of the absorbent body, and wherein at least one zone of SAP-material of the first variant is positioned longitudinally in front of and/or behind, and/or around the zone of SAP material of the second variant.

13. The absorbent product according to claim 1, wherein the SAP material of the second variant has an absorption capacity of at least 6 g blood/g SAP under load, and the first variant has an absorption capacity of at least 20 g salt solution/g SAP under load.

14. The absorbent product according to claim 1, wherein absorbent body has an amount of superabsorbent polymer material in the interval from 1 to 100%.

15. The absorbent product according to claim 1, wherein the absorbent product is a panty liner, sanitary napkin, or tampon.

16. The absorbent product according to claim 6, wherein the contact angle of the second SAP variant is lower than 40°.

17. The absorbent product according to claim 13, wherein the SAP material of the second variant has an absorption capacity of at least 10 g blood/g SAP under load.

18. The absorbent product according to claim 13, wherein the SAP material of the second variant has an absorption capacity of at least 13 g blood/g SAP under load.

19. The absorbent product according to claim 13, wherein the first variant has an absorption capacity of at least 30 g salt solution/g SAP under load.

20. The absorbent product according to claim 13, wherein the first variant has an absorption capacity of at least 35 g salt solution/g SAP under load.

21. The absorbent product according to claim 14, wherein the absorbent body has an amount of superabsorbent polymer material in the interval from 10% to 60%.
